(19) United States
(12) Patent Application Publication
(10) Pub. No.: US 2013/0113830 A1
(43) Pub. Date: May 9, 2013

(54) INFORMATION PROCESSING APPARATUS, DISPLAY CONTROL METHOD, AND PROGRAM

(71) Applicant: Sony Corporation, Tokyo (JP)

(72) Inventor: Seiji Suzuki, Kanagawa (JP)

(73) Assignee: Sony Corporation, Tokyo (JP)

(21) Appl. No.: 13/667,605

(22) Filed: Nov. 2, 2012

(30) Foreign Application Priority Data
Nov. 9, 2011 (JP) 2011-245302

(51) Int. Cl. G06T 3/00

(52) U.S. Cl. CPC G06T 3/00
USPC 345/634

(57) ABSTRACT

There is provided an information processing apparatus including: an operation detecting unit detecting an operation of a subject that has been captured, and a display control unit changing a worn state of at least one of virtual clothing or accessories displayed overlaid on the subject in accordance with the operation detected by the operation detecting unit.

### BACKGROUND

The present disclosure relates to an information processing apparatus, a display control method, and a program.

Various technologies for generating dressing images (i.e., images in which clothes or the like are tried on) by superimposing images of clothing onto images produced by capturing a user have been proposed as virtual dressing systems.

As one example, Japanese Laid-Open Patent Publication No. 2006-304331 discloses a process that superimposes images of clothing onto an image of the user's body. More specifically, the image processing server disclosed in Publication No. 2006-304331 changes the size of a clothing image and adjusts the orientation of the image based on information such as body profile data (height, shoulder width, and the like) appended to a body image of the user and the orientation of the body in the image, and then superimposes the clothing image on the body image.

### SUMMARY

With the dressing image generating technology disclosed in Publication No. 2006-304331, the clothing image to be superimposed is adjusted only by changing the size and adjusting the orientation and the state of a collar or sleeves of the clothing image is decided in advance, which means that it has been difficult to make partial changes to the clothing images. However, when a user actually tries on clothes, there is also demand for the ability to try different states for the collar or sleeves (hereinafter collectively referred to as the “worn state”) in accordance with the user's preference.

For this reason, the present disclosure aims to provide a novel and improved information processing apparatus, display control method, and program capable of changing a worn state in accordance with an operation by a subject.

According to the present disclosure, there is provided an information processing apparatus including an operation detecting unit detecting an operation of a subject that has been captured, and a display control unit changing a worn state of virtual clothing and/or accessories displayed overlaid on the subject in accordance with the operation detected by the operation detecting unit.

According to the present disclosure, there is provided a display control method including detecting an operation of a subject that has been captured, and changing a worn state of virtual clothing and/or accessories displayed overlaid on the subject in response to the detected operation.

According to the present disclosure, there is provided a program causing a computer to execute a process detecting an operation of a subject that has been captured, and a process changing a worn state of virtual clothing and/or accessories displayed overlaid on the subject in accordance with the detected operation.

According to the embodiments of the present disclosure described above, it is possible to change a worn state in accordance with an operation by a subject.

### BRIEF DESCRIPTION OF THE DRAWINGS

FIG. 1 is a diagram useful in explaining an overview of an AR dressing system according to an embodiment of the present disclosure;

FIG. 2 is a block diagram showing the configuration of an information processing apparatus according to the embodiment of the present disclosure;

FIG. 3 is a diagram useful in explaining the positional relationship between a camera and a subject in a real space and a picked-up image in which the subject is captured;

FIG. 4 is a diagram useful in explaining skeleton information according to the embodiment of the present disclosure;

FIG. 5 is a diagram useful in explaining the positional relationship between a virtual camera and virtual clothing in a virtual space and a virtual clothing image produced by projecting the virtual clothing;

FIG. 6 is a flowchart showing a fundamental display control process for displaying an AR dressing image according to the embodiment of the present disclosure;

FIG. 7 is a flowchart showing a control process for a worn state in accordance with a gesture according to the embodiment of the present disclosure;

FIG. 8 is a diagram useful in explaining Control Example 1 of the worn state in accordance with a valid gesture according to the embodiment of the present disclosure;

FIG. 9 is a diagram useful in explaining Control Example 4 of the worn state in accordance with a valid gesture according to the embodiment of the present disclosure;

FIG. 10 is a diagram useful in explaining a case where the position of a camera has been changed to behind the subject in the AR dressing system according to the embodiment of the present disclosure; and

FIG. 11 is a diagram useful in explaining a case where virtual clothing is displayed overlaid on a subject whose three-dimensional shape has been reconstructed in the AR dressing system according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the came function and structure are denoted with the same reference numerals, and repeated explanation of these structural elements is omitted.

The following description is given in the order indicated below.
1. Overview of AR Dressing System According to an Embodiment of the Present Disclosure
2. Configuration of Information Processing Apparatus
3. Display Control

3-1. Fundamental Display Control

3-2. Control of Worn State in Accordance With Gesture

3-3. Display from Objective Viewpoint
4. Conclusion

### 1. Overview of AR Dressing System According to an Embodiment of the Present Disclosure

In recent years, attention has been focused on a technology called augmented reality (AR) that presents additional information to the user by overlaying such information onto the real world. The information presented to the user by AR technology is visualized using virtual objects of a variety of forms, such as text, icons, and animations. One of the main uses of AR technology is to support user activities in the real world. In the following description, AR technology is applied to a dressing system (i.e., a system for trying on clothes and the like).

By displaying an image of virtual clothing overlaid on the body in keeping with a user operation, a dressing system that uses AR technology enables a user to virtually try on clothes in real time. Also, an AR dressing system according to an embodiment of the present disclosure is capable of changing the worn state of virtual clothing in accordance with a user operation and thereby provides an interactive virtual dressing room. By doing so, users can try on clothes with increased freedom and can enjoy styling clothes that are being virtually tried on.

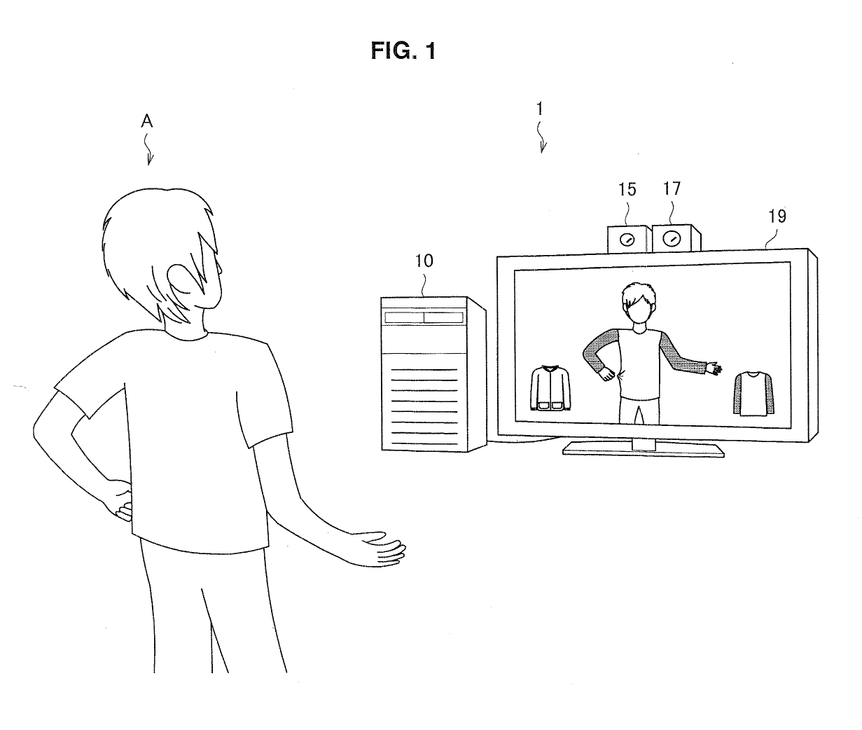

An overview of the AR dressing system according to the present embodiment of the disclosure will now be described with reference to FIG. 1. As shown in FIG. 1, an AR dressing system 1 according to the present embodiment of the disclosure includes an information processing apparatus 10, a camera 15, a sensor 17, and a display apparatus 19. Note that there are no particular limitations on the location where the AR dressing system 1 is set up. As examples, the AR dressing system 1 may be set up in the user's home or may be set up in a store.

Also, although the plurality of apparatuses that compose the AR dressing system 1 (that is, the information processing apparatus 10, the camera 15, the sensor 17, and the display apparatus 19) are configured as separate devices in the example shown in FIG. 1, the configuration of the AR dressing system 1 according to the present embodiment is not limited to this. For example, any combination of a plurality of apparatuses that compose the AR dressing system 1 may be integrated into a single apparatus. As another example, the plurality of apparatuses that compose the AR dressing system 1 may be incorporated into a smartphone, a PDA (personal digital assistant), a mobile phone, a mobile audio reproduction device, a mobile image processing device, or a mobile game console.

The camera (image pickup apparatus) 15 picks up images of an object present in a real space. Although there are no particular limitations on the object present in the real space, as examples such object may be an animate object such as a person or an animal or an inanimate object such as a garage or a television stand. In the example shown in FIG. 1, as the object present in a real space, the subject A (for example, a person) is captured by the camera 15. Images picked up by the camera 15 (hereinafter also referred to as “picked-up images”) are displayed on the display apparatus 19. The picked-up images displayed on the display apparatus 19 may be RGB images. Also, the camera 15 sends the picked-up images to the information processing apparatus 10.

The sensor 17 has a function for detecting parameters from the real space and sends detected data to the information processing apparatus 10. For example, if the sensor 17 is constructed of an infrared sensor, the sensor 17 is capable of detecting infrared waves from the real space and supplying an electrical signal in keeping with the detected amount of infrared as the detected data to the information processing apparatus 10. As one example, the information processing apparatus 10 is capable of recognizing the object present in the real space based on the detected data. The type of the sensor 17 is not limited to an infrared sensor. Note that although the detected data is supplied from the sensor 17 to the information processing apparatus 10 in the example shown in FIG. 1, the detected data supplied to the information processing apparatus 10 may be images picked up by the camera 15.

The information processing apparatus 10 is capable of processing the picked-up images, such as by superimposing a virtual object on the picked-up images and/or reshaping the picked-up images, in keeping with a recognition result for the object present in the real space. The display apparatus 19 is also capable of displaying the images processed by the information processing apparatus 10.

For example, as shown in FIG. 1, the information processing apparatus 10 is capable of recognizing the subject A in the real space and displaying dressing images in which a clothing image is superimposed on the display apparatus 19 in real time. In this example, the user's body is video of the real space and images of clothing to be tried on are a virtual object displayed by being overlaid on the video of the real space. By doing so, the AR dressing system 1 provides a virtual dressing room in real time.

The information processing apparatus 10 according to the present embodiment of the disclosure has a function for detecting an operation by the subject A. By doing so, the information processing apparatus 10 is capable of changing the clothing image to be superimposed on the picked-up image in accordance with the detected operation and thereby changing the worn state. By displaying AR dressing images in which the worn state changes in accordance with an operation by the subject A in real time on the display apparatus 19, it is possible to provide an interactive virtual dressing room.

### 2. Configuration of Information Processing Apparatus

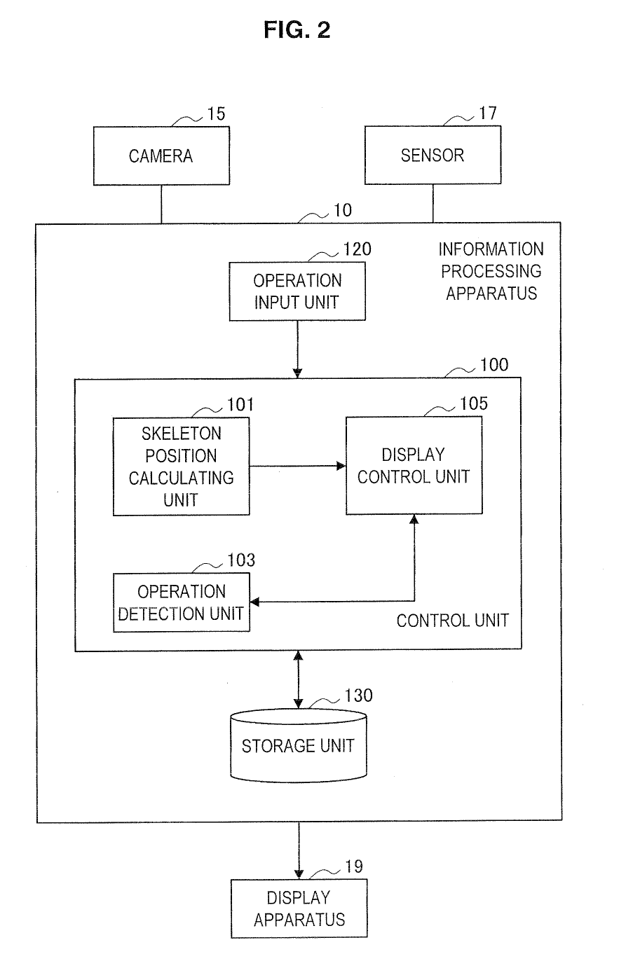

Next, the configuration of the information processing apparatus 10 that realizes the AR dressing system according to the present embodiment of the disclosure will be described with reference to FIG. 2. As shown in FIG. 2, the information processing apparatus 10 includes a control unit 100, an operation input unit 120, and a storage unit 130. The control unit 100 includes a skeleton position calculating unit 101, an operation detection unit 103, and a display control unit 105. The information processing apparatus 10 is also connected wirelessly or via wires to the camera 15, the sensor 17, and the display apparatus 19.

The control unit 100 corresponds to a processor such as a CPU (Central Processing Unit) or a DSP (Digital Signal Processor). By executing a program stored in the storage unit 130 or another storage medium, the control unit 100 realizes the variety of functions of the control unit 100, described later. Note that the respective blocks that compose the control unit 100 may all be incorporated in the same apparatus or some of such blocks may be incorporated in another apparatus (such as a server).

The storage unit 130 stores a program and data for processing by the information processing apparatus 10 using a storage medium such as a semiconductor memory or a hard disk. As one example, the storage unit 130 stores a program for causing a computer to function as the control unit 100. The storage unit 130 may also store data to be used by the control unit 100, for example. The storage unit 130 according to the present embodiment stores three-dimensional data for clothing and/or accessories, material information and size information associated with the clothing and/or accessories, as virtual objects to be displayed. Note that in the present specification, the expression “clothing and/or accessories” can include clothes and accessories. Here, the expression “accessories” includes eyeglasses, hats, belts, and the like.

The operation input unit 120 includes an input device, such as a mouse, a keyboard, a touch panel, a button or buttons, a microphone, a switch or switches, a lever or levers, or a remote controller, that enables the user to input information, an input control circuit that generates an input signal based on an input made by the user and outputs to the control unit 100, and the like. By operating the operation input unit 120, it is possible for the user to turn the power of the information processing apparatus 10 on and off and to give instructions such as launching an AR dressing system program.

The camera 15 (image pickup apparatus) generates picked-up images by capturing a real space using an image pickup element such as a CCD (Charge Coupled Device) or a CMOS (Complementary Metal Oxide Semiconductor). Although the camera 15 is assumed to be constructed separately to the information processing apparatus 10 in the present embodiment of the disclosure, the camera 15 may be part of the information processing apparatus 10.

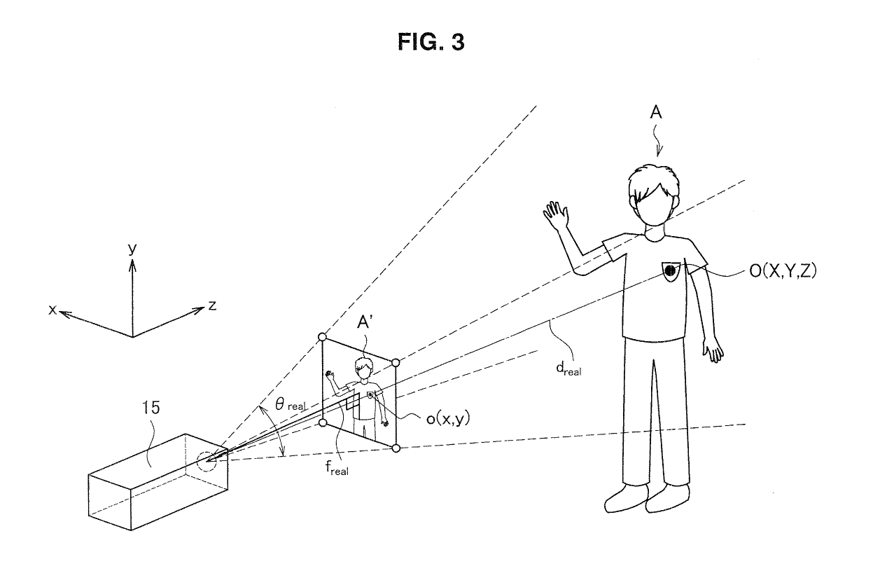

The camera 15 also supplies settings information of the camera 15 used during image pickup to the control unit 100. FIG. 3 is a diagram useful in explaining the positional relationship between the camera 15 and the subject A in the real space and a picked-up image A′ produced by capturing the subject A. For ease of illustration, in FIG. 3 the focal distance fᵣₑₐₗ from the principal point that is the optical center of the lens (not shown) of the camera 15 to the image pickup element (also not shown) of the camera 15 and the picked-up image A′ (which is two-dimensional with xy coordinates) of the subject A (which is three-dimensional with xyz coordinates) produced on the image pickup element are shown on the same side as the subject. As described later, the distance dᵣₑₐₗ from the camera 15 to the subject A is calculated as depth information. The angle of view θᵣₑₐₗ of the camera 15 is mainly decided according to the focal distance fᵣₑₐₗ. As an example of the settings information of the camera 15, the camera 15 supplies the focal distance fᵣₑₐₗ (or the angle of view θᵣₑₐₗ) and the resolution (that is, the number of pixels) of the picked-up image A′ to the information processing apparatus 10.

The sensor 17 has a function for detecting parameters from the real space. As one example, if the sensor 17 is constructed of an infrared sensor, the sensor 17 is capable of detecting infrared from the real space and supplying an electrical signal in keeping with the detected amount of infrared as detected data to the information processing apparatus 10. The type of sensor 17 is not limited to an infrared sensor. Note that if an image picked up by the camera 15 is supplied to the information processing apparatus 10 as the detected data, the sensor 17 does not need to be provided.

The display apparatus 19 is a display module constructed of an LCD (Liquid Crystal Display), an OLED (Organic Light-Emitting Diode), a CRT (Cathode Ray Tube) or the like. Although a configuration where the display apparatus 19 is constructed separately to the information processing apparatus 10 is imagined in the present embodiment of the disclosure, the display apparatus 19 may be part of the information processing apparatus 10.

Next, the functional configuration of the control unit 100 mentioned above will be described. As described earlier, the control unit 100 includes the skeleton position calculating unit 101, the operation detection unit 103, and the display control unit 105.

### Skeleton Position Calculating Unit 101

The skeleton position calculating unit 101 calculates the skeleton position of the body appearing in a picked-up image based on the detected data. There are no particular limitations on the method of calculating the skeleton position in the real space of the object appearing in a picked-up image. As one example, the skeleton position calculating unit 101 first recognizes a region in which an object is present in the picked-up image (also referred to as the “object-present region”) and acquires depth information of the object in the picked-up image. The skeleton position calculating unit 101 may then recognize the parts (head, left shoulder, right shoulder, torso, and the like) in the real space of the object appearing in the picked-up image based on the depth and form (feature amounts) of the object-present region and calculate center positions of the respective parts as the skeleton position. Here, the skeleton position calculating unit 101 is capable of using a feature amount dictionary stored in the storage unit 130 to compare feature amounts decided from a picked-up image with feature amounts for each part of an object registered in advance in the feature amount dictionary and thereby recognize the parts of the object included in the picked-up image.

Various methods can be conceivably used to recognize the object-present region. For example, if a picked-up image is supplied to the information processing apparatus 10 as detected data, the skeleton position calculating unit 101 can recognize the object-present region based on differences between a picked-up image before the object appears and a picked-up image in which the object appears. In more detail, the skeleton position calculating unit 101 is capable of recognizing a region in which the difference between a picked-up image before the object appears and a picked-up image in which the object appears exceeds a threshold as the object-present region.

As another example, if parameters detected by the sensor 17 have been supplied to the information processing apparatus 10 as the detected data, the skeleton position calculating unit 101 is capable of recognizing the object-present region based on the detected data. In more detail, the skeleton position calculating unit 101 is capable of recognizing a region in which the detected amount of infrared exceeds a threshold as the object-present region.

Various methods can be conceivably used to acquire the depth information of an object in a picked-up image. For example, it is possible to decide the distance between the camera 15 and the object in advance. That is, it is possible to set a limitation that the object is disposed at a position a distance decided in advance away from the camera 15. If such a limitation is provided, it is possible for the skeleton position calculating unit 101 to treat the depth information of the object (here, the distance between the camera 15 and the object) as a fixed value (for example, 2 m).

The skeleton position calculating unit 101 is also capable of calculating the depth information of the object in a picked-up image based on parameters calculated by the sensor 17. In more detail, if the skeleton position calculating unit 101 emits light such as infrared toward the object from an emitter device (not shown), it will be possible to calculate depth information for the object in the picked-up image by analyzing the light detected by the sensor 17.

As another example, the skeleton position calculating unit 101 is capable of calculating the depth information of the object in a picked-up image based on a phase delay of light detected by the sensor 17. This method is sometimes referred to as TOF (Time Of Flight). Alternatively, if the light emitted from an emitter device (not shown), is composed of a known pattern, the skeleton position calculating unit 101 may calculate the depth information of the object in a picked-up image by analyzing the degree of distortion of the pattern constructed by the light detected by the sensor 17.

Note that an image pickup apparatus with a function for calculating depth information of an object in a picked-up image is referred to as a depth camera and can be realized by a stereo camera or a laser range scanner. The skeleton position calculating unit 101 may acquire the depth information from a depth camera that is connected to the information processing apparatus 10.

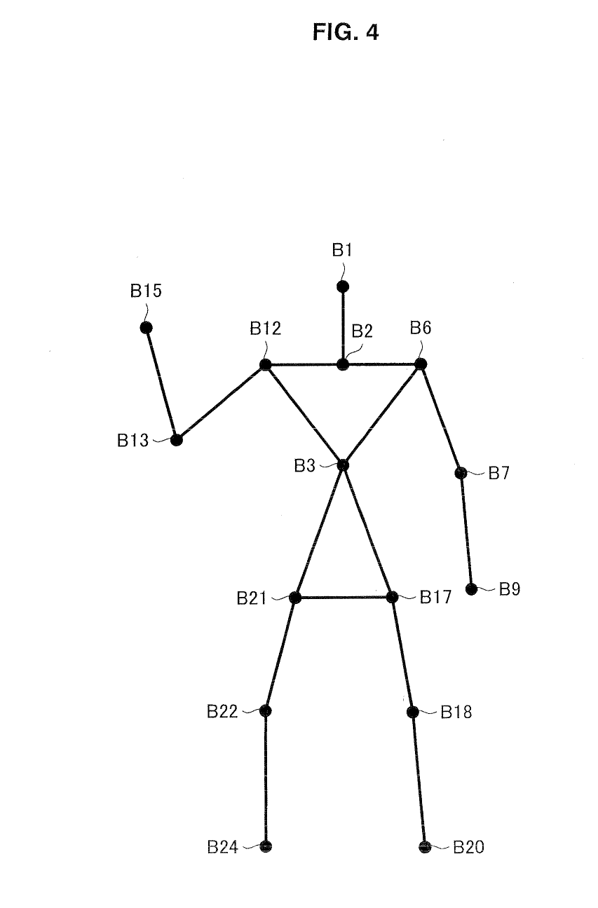

Based on the depth and form (feature amounts) of the object-present region acquired by the methods described above, the skeleton position calculating unit 101 recognizes the parts (head, shoulders, and the like) in the real space of the object appearing in a picked-up image and calculates the skeleton position of the respective parts. Skeleton information including the skeleton position of at least one part that constructs the subject A calculated by the skeleton position calculating unit 101 will now be described with reference to FIG. 4.

FIG. 4 is a diagram useful in explaining skeleton information. Although the coordinates B1 to B3, B6, B7, B9, B12, B13, B15, B17, B18, B20 to B22, and B24 showing the positions of fifteen parts that construct the subject A are given as one example of the skeleton information in FIG. 4, there are no particular limitations on the number of parts included in the skeleton information.

Note that the coordinates B1 show coordinates of the “Head”, the coordinates B2 show coordinates of the “Neck”, the coordinates B3 show coordinates of the “Torso”, the coordinates B6 show coordinates of the “Right Shoulder”, and the coordinates B7 show coordinates of the “Right Elbow”. Additionally, the coordinates B9 show coordinates of the “Right Hand”, the coordinates B12 show coordinates of the “Left Shoulder”, the coordinates B13 show coordinates of the “Left Elbow”, and the coordinates B15 show coordinates of the “Left Hand”.

The coordinates B17 show coordinates of the “Right Flip”, the coordinates B18 show coordinates of the “Right Knee”, the coordinates B20 show coordinates of the “Right Foot”, and the coordinates B21 show coordinates of the “Left Hip”. The coordinates B22 show coordinates of the “Left Knee” and the coordinates B24 show coordinates of the “Left Foot”.

The skeleton position calculating unit 101 according to the present embodiment acquires depth information for an object in a picked-up image as described earlier, and as a specific example the depth information may be acquired from the depth camera described above as a picked-up image (not shown) in which shading changes in accordance with the depth.

### Operation Detection Unit 103

The operation detection unit 103 detects operations based on changes over time in the skeleton position calculated by the skeleton position calculating unit 101 and if a valid gesture has been made, outputs the detected valid gesture to the display control unit 105. The operation detection unit 103 compares a detected operation with gestures registered in a gesture DB (database) stored in advance in the storage unit 130 to determine whether the detected operation is a valid gesture. As one example, an operation where the subject A moves his/her hand to the outside from a position where the virtual clothing is displayed overlaid on the subject A is registered in the gesture DB as a valid gesture of grasping and pulling the clothing. As another example, an operation where the subject moves one hand from the other wrist toward the elbow is registered in the gesture DB as a valid gesture of rolling up the sleeves.

Note that detection of an operation by the subject (for example, a person) in the real space may be realized by operation detection based on the skeleton information described earlier or by another technology generally referred to as “motion capture”. For example, the operation detection unit 103 may detect an operation by the subject based on detected parameters from acceleration sensors or the like attached to joints of the subject. The operation detection unit 103 may also detect the operation by detecting movement of markers attached to the subject.

### Display Control Unit 105

The display control unit 105 carries out control that generates an AR dressing image where virtual clothing is displayed overlaid on a subject appearing in a picked-up image and displays the AR dressing image on the display apparatus 19. The display control unit 105 according to the present embodiment is capable of changing the worn state in an AR dressing image in accordance with an operation (i.e., a valid gesture) detected by the operation detection unit 103. More specifically, the display control unit 105 is capable of providing an interactive dressing room where the worn state of part or all of the virtual clothing is changed in accordance with a gesture (i.e., a change in a time series of coordinates) by the subject and the position (coordinates) of such gesture.

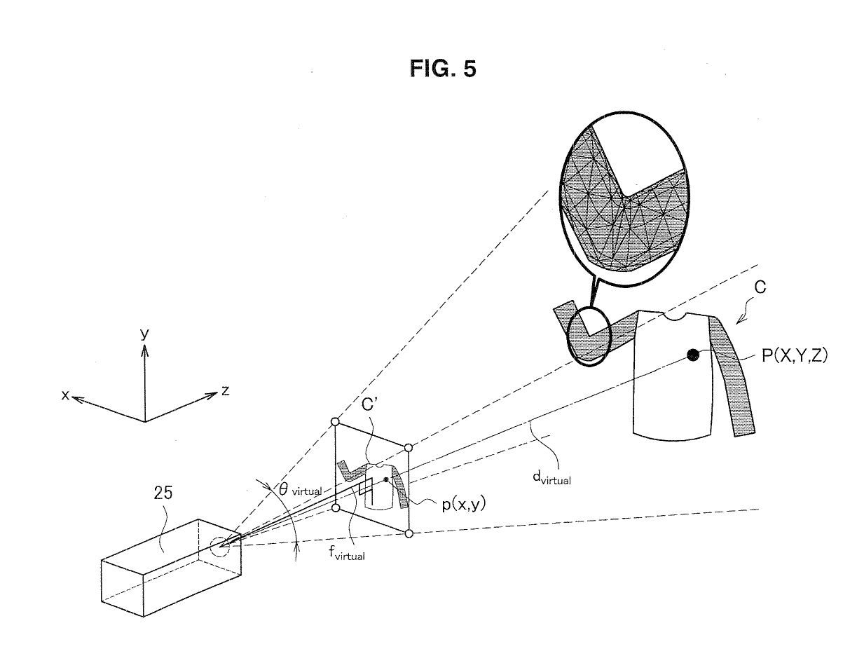

Here, generation of the virtual clothing to be overlaid on the picked-up image will be described with reference to FIG. 5. FIG. 5 is a diagram useful in explaining the positional relationship between the virtual camera 25 and the virtual clothing C in the virtual space and the virtual clothing image C′ (also referred to as the “virtual image”) produced by projecting (rendering) the virtual clothing C. In FIG. 5, in the same way as the picked-up image A′ produced by capturing the real space shown in FIG. 3, the rendered virtual clothing image C′ is shown on same side as the virtual clothing.

The settings (internal parameters) of the virtual camera 25 are decided in accordance with the settings (internal parameters) of the camera 15 that captures the real space. The expression “settings (internal parameters) of the camera” may for example be focal distance f, angle θ, and number of pixels. The display control unit 105 sets the settings of the virtual camera 25 so as to match the camera 15 of the real space (this process is also referred to as “initialization”).

Next, based on the depth information of the object in the picked-up image, the display control unit 105 disposes the virtual clothing C in accordance with the skeleton position of the subject at a position that is separated from the virtual camera 25 by a distance dᵥᵢᵣₜᵤₐₗ that is the same as the distance dᵣₑₐₗ from the camera 15 to the subject A in the real space. The display control unit 105 may generate the virtual clothing C based on three-dimensional data that has been modeled in advance. As shown in FIG. 5, for example, the display control unit 105 is capable of representing the three-dimensional form of the virtual clothing in a more realistic manner by constructing the surfaces of the virtual clothing C from a set of triangular polygons. If the skeleton position of the subject A changes over time, the display control unit 105 is capable of changing the position of the virtual clothing C so as to track the skeleton position.

Next, the display control unit 105 acquires the clothing image C′ (or “virtual image”) by rendering, that is, projecting the three-dimensional virtual clothing C to produce a two-dimensional flat image using the virtual camera 25. The display control unit 105 can then generate the AR dressing image by displaying the virtual clothing image C′ overlaid on the picked-up image A′ (see FIG. 3). Note that display control of an AR dressing image by the display control unit 105 will be described in more detail next in the “3. Display Control” section.

This completes the detailed description of the configuration of the information processing apparatus 10 that realizes the AR dressing system according to the present embodiment of the disclosure. Next, display control for an AR dressing image by the information processing apparatus 10 will be described.

### 3. Display Control

3-1. Fundamental Display Control

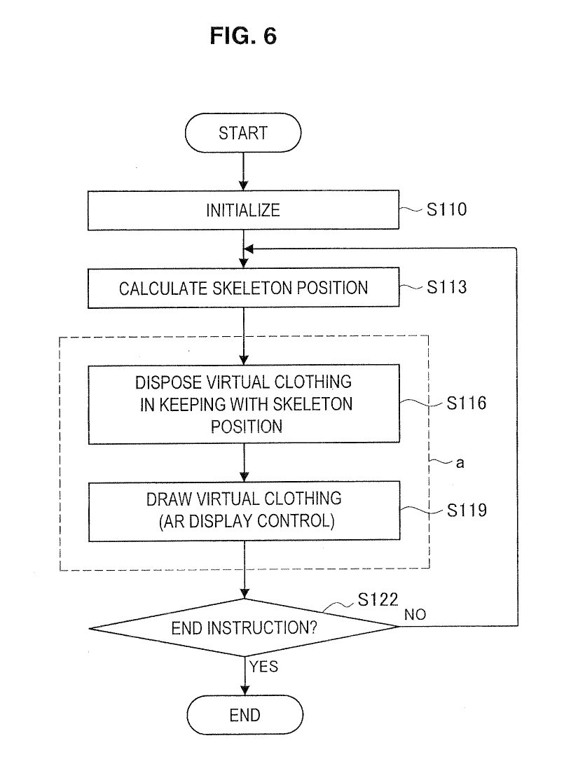

FIG. 6 is a flowchart showing the fundamental display control process for an AR dressing image carried out by the information processing apparatus 10. As shown in FIG. 6, first, in step S110, the display control unit 105 carries out initialization to make the settings of the virtual camera 25 in the virtual space match the settings of the camera 15 in the real space.

Next, in step S113, the skeleton position calculating unit 101 calculates the skeleton position (xyz coordinates) of the subject A in the real space that has been captured and outputs the skeleton position to the operation detection unit 103 and the display control unit 105.

After this, in step S116, the display control unit 105 disposes the virtual clothing C in a virtual space in accordance with the skeleton position (xyz coordinates) of the subject A.

Next, in step S119, the display control unit 105 carries out control (AR display control) that renders the virtual clothing C to acquire the clothing image C′ (virtual image), draws the AR dressing image by superimposing the clothing image C′ on the picked-up image A′, and displays the picked-up image A′ on the display apparatus 19.

In step S122, the information processing apparatus 10 repeatedly carries out step S113 to S119 until an end instruction is given. By doing so, the information processing apparatus 10 is capable of providing AR dressing images that track the movement of the subject A in real time.

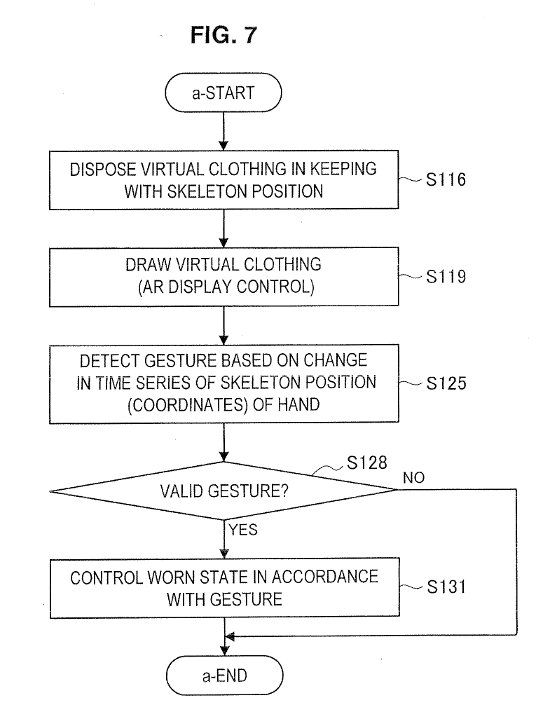

This completes the description of the fundamental display control process. In addition, the information processing apparatus 10 according to the present embodiment is capable of changing the worn state of virtual clothing in accordance with an operation by the subject A. Control of the worn state in accordance with a gesture according to the present embodiment will now be described in detail with reference to FIG. 7.

3-2. Control of Worn State in Accordance With Gesture

FIG. 7 is a flowchart showing a control process for a worn state in accordance with a gesture carried out by the information processing apparatus 10 according to the present embodiment. The process shown in FIG. 7 shows the control of the worn state carried out by the display control a in steps S116 and S119 shown in FIG. 6.

First, in step S116 in FIG. 7, in the same way as in the processing in the same step shown in FIG. 6, the virtual clothing C is disposed in a virtual space in keeping with the skeleton position of the subject A. Next, in step S119, in the same way as in the processing in the same step shown in FIG. 6, by displaying the clothing image C′ acquired by rendering the virtual clothing C overlaid on the picked-up image A′, a basic AR dressing image is displayed on the display apparatus 19.

Next, in step S125, the operation detection unit 103 detects a gesture (operation) based on changes in a time series of the skeleton position (coordinates) of the hand.

After this, in step S128, the operation detection unit 103 determines whether the detected gesture is a valid gesture.

In step S131, the display control unit 105 then controls the worn state in accordance with the gesture detected as a valid gesture by the operation detection unit 103. Such control of the worn state may modify part or all of the virtual clothing C in a three-dimensional space (virtual space) or may modify part or all of a virtual clothing image C′ in a two-dimensional image (virtual image) acquired by rendering.

The valid gestures described earlier and control of (i.e., changes to) the worn state may be combined in a variety of conceivable ways. Control of the worn state in accordance with a valid gesture according to an embodiment of the present disclosure will now be described in detail by way of a plurality of examples.

### CONTROL EXAMPLE 1 OF WORN STATE

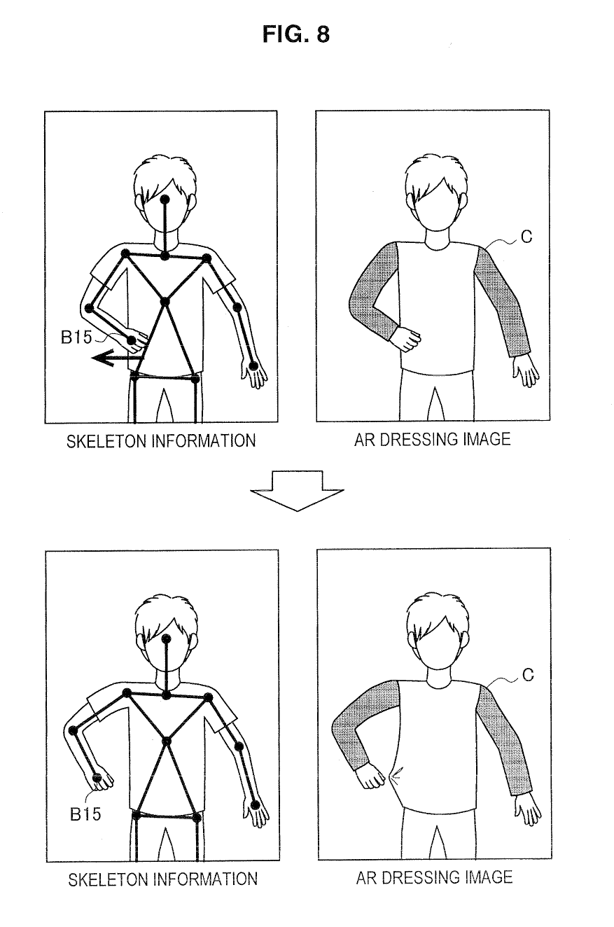

FIG. 8 is a diagram useful in explaining Control Example 1 of the worn state in accordance with a valid gesture according to the present embodiment. Note that the left side of FIG. 8 is composed of transition diagrams for an image where the picked-up image and skeleton information of the subject have been superimposed. The operation detection unit 103 detects an operation based on changes in a time series of the skeleton position as shown on the left in FIG. 8. The right side of FIG. 8 is composed of transition diagrams for an AR dressing image displayed by the display control unit 105 on the display apparatus 19. The display control unit 105 displays the virtual clothing overlaid on the subject based on a skeleton position calculated by the skeleton position calculating unit 101, such as that shown on the left in FIG. 8. The display control unit 105 changes the worn state of the virtual clothing in accordance with movement such as that shown on the left in FIG. 8 detected by the operation detection unit 103.

As shown in the transition diagrams for the skeleton position on the left in FIG. 8, if the coordinates B15 (Left Hand) of the subject have changed in a time series from a position that is displayed overlaid on the virtual clothing to a position to the outside, the operation detection unit 103 determines a valid gesture of grasping and pulling the clothing. In this case, the display control unit 105 changes part of the virtual clothing C in accordance with the operation by the subject as shown by the transition diagrams for the AR dressing image on the right of FIG. 8 (more specifically, the display control unit 105 moves feature points of part of the virtual clothing C to the outside). By doing so, it is possible to change the worn state of the AR dressing images so that the virtual clothing C is represented in a pulled-out state.

Note that when the virtual clothing C is changed in accordance with an operation by the subject, the display control unit 105 may decide the extent of change for the virtual clothing C based on material information stored in association with the virtual clothing C. By doing so, it is possible to make the AR dressing images more realistic by having the representation of the pulled-out state change according to the stretchability of the material of the virtual clothing C.

### CONTROL EXAMPLE 2 OF WORN STATE

When the coordinates of one hand of the subject have changed in a time series from the coordinates of the other hand toward the coordinates of the elbow, the operation detection unit 103 determines a valid gesture of rolling up the sleeves (or “sleeve rolling operation”). In this case, by changing part of the virtual clothing C in accordance with the sleeve rolling operation by the subject (for example, by moving the feature points of a sleeve part of the virtual clothing C in the direction of the elbow), the display control unit 105 is capable of controlling the worn state in the AR dressing images so as to represent the sleeves of the virtual clothing C in a rolled-up state.

If the coordinates of the hand of the subject have changed in a time series from the base of the neck to the chin, the operation detection unit 103 determines a valid gesture of raising a collar. In this case, by changing the virtual clothing C in accordance with the operation by the subject (more specifically, by moving feature points of the collar part of the virtual clothing C toward the chin), the display control unit 105 is capable of changing the worn state in the AR dressing images so that a state where the collar of the virtual clothing C is raised is represented.

Note that if an opposite operation to the sleeve rolling or collar raising operation described above is detected, it is possible to control the worn state in the AR dressing images in the same way.

### CONTROL EXAMPLE 4 OF WORN STATE

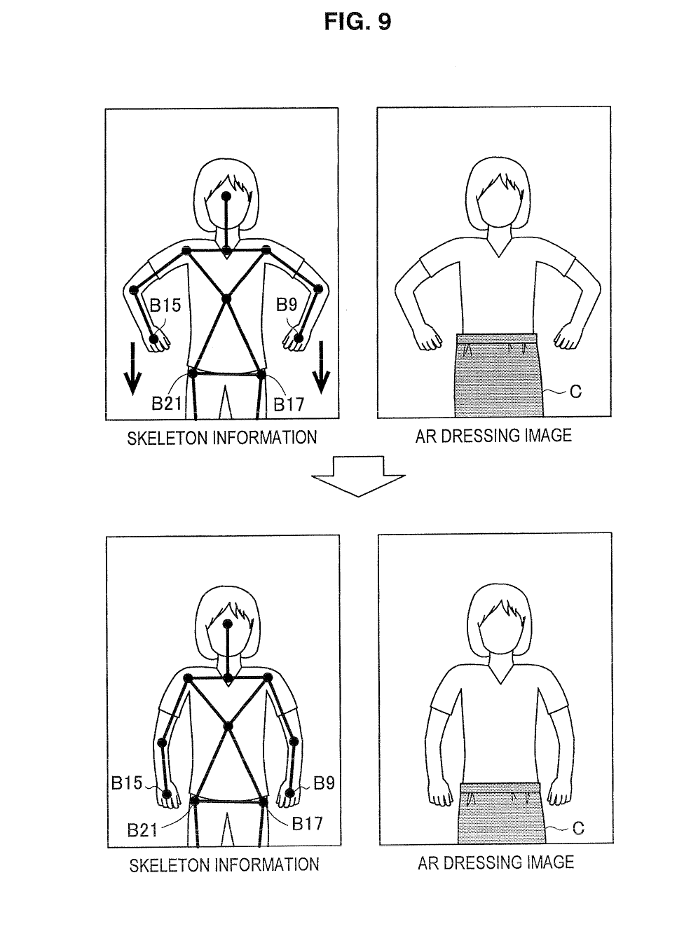

In addition, the display control unit 105 is capable of adjusting the waist position of trousers or a skirt in accordance with an operation by the subject. FIG. 9 is a diagram useful in explaining Control Example 4 of the worn state in accordance with a valid gesture according to the present embodiment.

As shown by the transition diagrams for the skeleton position on the left in FIG. 9, if the coordinates B9 and B15 of the subject have changed in a time series so as to move in substantially the vertical direction to the vicinity of the coordinates B17 and B21, the operation detection unit 103 determines a valid gesture of lowering the waist position of clothing. In this case, the display control unit 105 changes the virtual clothing C in accordance with the operation by the subject as shown by the transition diagrams for the AR dressing image on the right in FIG. 9 (more specifically, the display control unit 105 moves all feature points of the virtual clothing C downward). By doing so, it is possible to change the worn state in the AR dressing images by representing a state where the waist position of the virtual clothing C has been lowered.

Since the waist position of the virtual clothing C is adjusted in accordance with the operation of the hands, in the AR dressing images the user is capable of trying different styles, such as by wearing trousers or a skirt high or low on the body.

Here, the size of the virtual clothing to be displayed overlaid on the subject is normally transformed (reshaped) in accordance with the size of the subject. More specifically, by disposing the virtual clothing C in accordance with the skeleton position of the subject in the virtual space as shown in FIG. 5 for example, the size of the virtual clothing C is transformed in keeping with the size of the subject. However, there are also cases where the user of an AR dressing system wishes to test the fit of clothes which in reality have specified sizes.

For this reason, the display control unit 105 may display AR dressing images produced by disposing virtual clothing of a specified size in the virtual space shown in FIG. 5, for example, at a depth (distance) dᵥᵢᵣₜᵤₐₗ that is equal to the depth dᵣₑₐₗ in the real space and superimposing a virtual image produced by projecting the virtual clothing on picked-up images. By doing so, the user is capable of comparing the size of the user's body with the size of the virtual clothing of a specified size.

When virtual clothing of a specified size has been displayed overlaid on the subject in this way, by further carrying out control of the worn state of the virtual clothing in accordance with an operation by the subject as described earlier, it is possible for the user to confirm the fit of the virtual clothing. For example, by adjusting the waist position of virtual trousers or a virtual skirt to an optimal waist position, it is possible to confirm the fit of the virtual clothing C at the optimal waist position.

This completes the description of control of the worn state in accordance with an operation by the subject according to the present embodiment by way of a plurality of specific examples. Next, the positioning of the camera 15 included in the AR dressing system 1 will be described in detail.

3-3. Display from Objective Viewpoint

In the AR dressing system according to the embodiment of the disclosure described above, by disposing the camera 15 and the display apparatus 19 in front of the subject A as shown in FIG I and displaying the virtual clothing overlaid on the subject A who is facing forward, AR dressing images are displayed from the same viewpoint as when the subject A tries on clothes in front of a mirror. However, in such case, it is difficult for the subject to confirm how the clothes look when viewed by another person (i.e., from another angle). For this reason, by using the plurality of methods described below, the AR dressing system according to the present embodiment of the disclosure is capable of producing AR dressing images from an objective viewpoint.

### Changing the Position of Camera 15

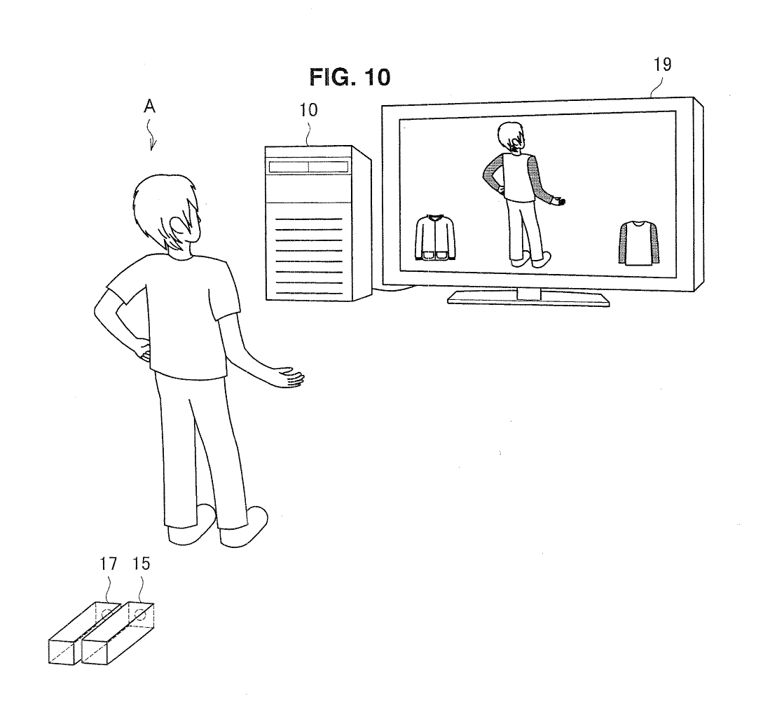

Although the camera 15 and the display apparatus 19 are disposed in front of the subject A in FIG. 1, the position of the camera IS may be changed to behind the subject A as shown in FIG. 10. In this case, the rear figure of the subject A is captured by the camera 15 and the display control unit 105 displays AR dressing images in which the virtual clothing is overlaid on the rear figure of the subject A on the display apparatus 19 that is positioned in front of the subject A. By doing so, the user is capable of checking the rear figure of himself/herself in an AR dressed state. In this case, it is obviously necessary to use a rear view of the virtual clothing overlaid on the rear figure of the subject, and therefore the display control unit 105 draws the virtual clothing based on virtual clothing data for a rear view.

Although an example where the position of the camera 15 is changed to behind the subject A has been given, it is also possible to realize display control of AR dressing images from an objective viewpoint by changing the position of the camera 15 to other positions, such as to the side of or at an angle to the subject A. Note that since the orientation of the virtual clothing will also differ according to the orientation of the subject A, the information processing apparatus 10 is capable of coping by having virtual clothing data from a variety of orientation. Alternatively, by using three-dimensional data of virtual clothing modeled in advance, the information processing apparatus 10 is capable of drawing virtual clothing from a variety of orientations.

### Delayed Display

Also, even if the camera 15 is disposed as shown in FIG. 1, by having the display control unit 105 display AR dressing images on the display apparatus 19 with a time lag instead of simply displaying in real time, it is possible for the user to confirm his/her own AR dressed figure from an objective viewpoint.

For example, if the display control unit 105 carries out control that displays

AR dressing images with a one-second delay on the display apparatus 19, immediately after the user has taken two seconds to rotate his/her body once in a substantially horizontal direction, an AR dressing image of the rear taken one second previously will be displayed on the display apparatus 19. In this way, by displaying an AR dressing image with a delay, it becomes possible for the user to confirm his/her own AR dressed figure from an objective viewpoint.

Also, the information processing apparatus 10 may record AR dressing images (moving images) in which the subject rotates and play back the AR dressing images while fast forwarding or rewinding in accordance with instructions from the user. By doing so, the user is capable of confirming his/her AR dressed figure from an objective viewpoint.

### Display According to Three-Dimensional Shape Reconstruction

The information processing apparatus 10 is capable of displaying AR dressing images from an objective viewpoint by reconstructing the three-dimensional shape of a captured subject and displaying the virtual clothing overlaid on the subject whose three-dimensional shape has been reconstructed from an arbitrary direction.

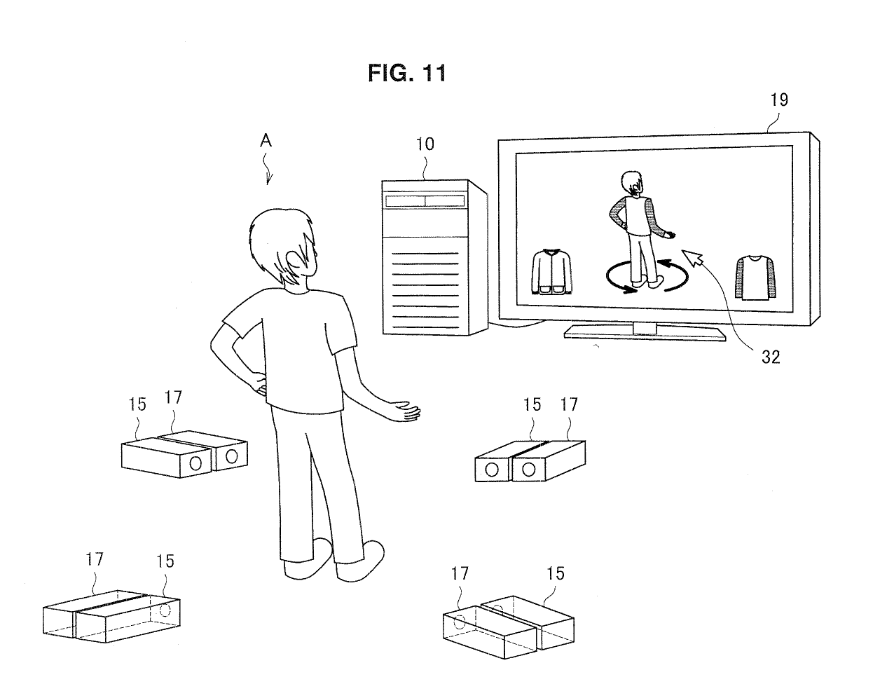

To reconstruct the three-dimensional shape of a subject, many cameras 15 and sensors 17 are disposed and the subject is captured from many viewpoints as shown in FIG. 11 for example. By doing so, the information processing apparatus 10 is capable of reconstructing the three-dimensional shape of the subject in real time. Note that although the subject is captured from many viewpoints and the three-dimensional shape is reconstructed in the example shown in FIG. 11, the method of reconstructing the three-dimensional shape is not limited to this and the shape may be reconstructed using two cameras or a single camera.

In this way, the virtual clothing is displayed overlaid on the subject whose three-dimensional shape has been reconstructed in real time, and by operating a mouse icon 32 as shown in FIG. 11, the user is capable of freely rotating the subject whose three-dimensional shape has been reconstructed. By doing so, the user is capable of confirming his/her figure from a variety of angles in real time when trying on the virtual clothing.

The information processing apparatus 10 may carry out reconstruction of the three-dimensional shape afterward at a later time based on images of a subject picked up in advance and display arbitrary virtual clothing overlaid on the subject. In this case, by operating the mouse icon 32 to freely rotate the subject whose three-dimensional shape has been reconstructed, it is possible for the user to confirm a subject who is trying on virtual clothing from a variety of angles.

Note that if AR dressing images of the subject are displayed in real time as shown in FIG. 11 for example, aside from a mouse, the device for operating the mouse icon 32 may be a remote controller (not shown).

### 4. Conclusion

As described earlier, according to the AR dressing system 1 according to the above embodiment of the disclosure, by controlling the worn state in accordance with an action of the subject, it is possible for the user to try a variety of styles. Also, by realizing an interactive dressing room using the AR dressing system according to the above embodiment of the disclosure, it is possible to provide AR dressing images that are more realistic.

Also, according to the above embodiment, it is possible to confirm the AR dressed figure of the subject from an objective viewpoint, such as the rear figure or side figure of the subject.

It should be understood by those skilled in the art that various modifications, combinations, sub-combinations and alterations may occur depending on design requirements and other factors insofar as they are within the scope of the appended claims or the equivalents thereof.

In addition, although an example where virtual clothing is tried on has been mainly described for the AR dressing system described above, the items to be tried on are not limited to clothes and may be accessories such as eyeglasses, hats, and belts.

Also, although the case where the subject is a person has been described for the AR dressing system described earlier, the subject is not limited to a person and may be an animal such as a dog or a cat. In such case, it is possible to provide an AR dressing system that displays an image of pet clothing, for example, overlaid on a picked-up image in which an animal is captured.

Additionally, the present technology may also be configured as below.

(1)

An information processing apparatus including:

an operation detecting unit detecting an operation of a subject that has been captured; and

a display control unit changing a worn state of at least one of virtual clothing or accessories displayed overlaid on the subject in accordance with the operation detected by the operation detecting unit.

(2)

The information processing apparatus according to (1),

wherein the display control unit changes part or all of at least one of the virtual clothing or accessories in accordance with an operation position of the subject.

(3)

The information processing apparatus according to (2),

wherein the display control unit decides an extent of change to at least one of the clothing or accessories based on material information associated with at least one of the clothing or accessories.

(4)

The information processing apparatus according to any one of (1) to (3),

wherein the display control unit moves feature points showing features of a form of at least one of the virtual clothing or accessories in accordance with a position of the operation detected by the operation detecting unit.

(5)

The information processing apparatus according to any one of (1) to (4),

wherein the operation detecting unit detects an operation where the subject grasps and pulls with a hand, and

the display control unit changes the worn state by stretching part of at least one of the virtual clothing or accessories in a direction in which the subject has pulled.

(6)

The information processing apparatus according to any one of (1) to (5),

wherein the operation detecting unit detects a sleeve rolling operation where the subject moves one hand from a wrist of another hand toward an elbow, and

the display control unit changes the worn state by moving a sleeve of virtual clothing to be displayed overlaid on the subject toward the elbow in accordance with the sleeve rolling operation.

(7)

The information processing apparatus according to any one of (1) to (6),

wherein the operation detecting unit detects an operation where the subject raises a collar, and

the display control unit changes the worn state by raising a collar of virtual clothing to be displayed overlaid on the subject in accordance with the operation raising the collar.

(8)

The information processing apparatus according to any one of (1) to (7),

wherein the operation detecting unit detects an operation where the subject raises or lowers a waist position of clothing, and

the display control unit changes the worn state by adjusting a position of virtual clothing to be displayed overlaid on the subject in accordance with the operation that raises or lowers the waist position of the clothing.

(9)

A display control method including:

detecting an operation of a subject that has been captured; and

changing a worn state of at least one of virtual clothing or accessories displayed overlaid on the subject in response to the detected operation.

(10)

A program causing a computer to execute:

a process detecting an operation of a subject that has been captured; and

a process changing a worn state of at least one of virtual clothing or accessories displayed overlaid on the subject in accordance with the detected operation.

(11)

The program according to (10),

wherein the process of changing changes part or all of at least one of the virtual clothing or accessories in accordance with an operation position of the subject.

(12)

The program according to (11),

wherein the process of changing decides an extent of change to at least one of the clothing or accessories based on material information associated with at least one of the clothing or accessories.

(13)

The program according to any one of (10) to (12),

wherein the process of changing moves feature points showing features of a form of at least one of the virtual clothing or accessories in accordance with a position of the detected operation.

(14)

The program according to any one of (10) to (13),

wherein the process of detecting detects an operation where the subject grasps and pulls with a hand, and

the process of changing changes the worn state by stretching part of at least one of the virtual clothing or accessories in a direction in which the subject has pulled.

(15)

The program according to any one of (10) to (14),

wherein the process of detecting detects a sleeve rolling operation where the subject moves one hand from a wrist of another hand toward an elbow, and

the process of changing changes the worn state by moving a sleeve of virtual clothing to be displayed overlaid on the subject toward the elbow in accordance with the sleeve rolling operation.

(16)

The program according to any one of (10) to (15),

wherein the process of detecting detects an operation where the subject raises a collar, and

the process of changing changes the worn state by raising a collar of virtual clothing to be displayed overlaid on the subject in accordance with the operation raising the collar.

(17)

The program according to any one of (10) to (16),

wherein the process of detecting detects an operation where the subject raises or lowers a waist position of clothing, and

the process of changing changes the worn state by adjusting a position of virtual clothing to be displayed overlaid on the subject in accordance with the operation that raises or lowers the waist position of the clothing.

The present disclosure contains subject matter related to that disclosed in Japanese Priority Patent Application JP 2011-245302 filed in the Japan Patent Office on Nov. 9, 2011, the entire content of which is hereby incorporated by reference.

What is claimed is:

1. An information processing apparatus comprising:
an operation detecting unit detecting an operation of a subject that has been captured; and
a display control unit changing a worn state of at least one of virtual clothing or accessories displayed overlaid on the subject in accordance with the operation detected by the operation detecting unit.

2. The information processing apparatus according to claim 1,
wherein the display control unit changes part or all of at least one of the virtual clothing or accessories in accordance with an operation position of the subject.

3. The information processing apparatus according to claim 2,
wherein the display control unit decides an extent of change to at least one of the clothing or accessories based on material information associated with the clothing or accessories.

4. The information processing apparatus according to claim 2,
wherein the display control unit moves feature points showing features of a form of at least one of the virtual clothing or accessories in accordance with a position of the operation detected by the operation detecting unit.

5. The information processing apparatus according to claim 2,
wherein the operation detecting unit detects an operation where the subject grasps and pulls with a hand, and
the display control unit changes the worn state by stretching part of at least one of the virtual clothing or accessories in a direction in which the subject has pulled.

6. The information processing apparatus according to claim 2,
wherein the operation detecting unit detects a sleeve rolling operation where the subject moves one hand from a wrist of another hand toward an elbow, and
the display control unit changes the worn state by moving a sleeve of virtual clothing to be displayed overlaid on the subject toward the elbow in accordance with the sleeve rolling operation.

7. The information processing apparatus according to claim 2,
wherein the operation detecting unit detects an operation where the subject raises a collar, and
the display control unit changes the worn state by raising a collar of virtual clothing to be displayed overlaid on the subject in accordance with the operation raising the collar.

8. The information processing apparatus according to claim 2,
wherein the operation detecting unit detects an operation where the subject raises or lowers a waist position of clothing, and
the display control unit changes the worn state by adjusting a position of virtual clothing to be displayed overlaid on the subject in accordance with the operation that raises or lowers the waist position of the clothing.

9. A display control method comprising:
detecting an operation of a subject that has been captured; and
changing a worn state of at least one of virtual clothing or accessories displayed overlaid on the subject in response to the detected operation.

10. A program causing a computer to execute:
a process detecting an operation of a subject that has been captured; and
a process changing a worn state of at least one of virtual clothing or accessories displayed overlaid on the subject in accordance with the detected operation.

11. The program according to claim 10,
wherein the process of changing changes part or all of at least one of the virtual clothing or accessories in accordance with an operation position of the subject.

12. The program according to claim 11,
wherein the process of changing decides an extent of change to at least one of the clothing or accessories based on material information associated with at least one of the clothing or accessories.

13. The program according to claim 11,
wherein the process of changing moves feature points showing features of a form of at least one of the virtual clothing or accessories in accordance with a position of the detected operation.

14. The program according to claim 11,
wherein the process of detecting detects an operation where the subject grasps and pulls with a hand, and
the process of changing changes the worn state by stretching part of at least one of the virtual clothing or accessories in a direction in which the subject has pulled.

15. The program according to claim 11,
wherein the process of detecting detects a sleeve rolling operation where the subject moves one hand from a wrist of another hand toward an elbow, and
the process of changing changes the worn state by moving a sleeve of virtual clothing to be displayed overlaid on the subject toward the elbow in accordance with the sleeve rolling operation.

16. The program according to claim 11,
wherein the process of detecting detects an operation where the subject raises a collar, and
the process of changing changes the worn state by raising a collar of virtual clothing to be displayed overlaid on the subject in accordance with the operation raising the collar.

17. The program according to claim 11,
wherein the process of detecting detects an operation where the subject raises or lowers a waist position of clothing, and
the process of changing changes the worn state by adjusting a position of virtual clothing to be displayed overlaid on the subject in accordance with the operation that raises or lowers the waist position of the clothing.
